(19) United States
(12) Patent Application Publication
(10) Pub. No.: US 2026/0203401 A1
(43) Pub. Date: Jul. 16, 2026

(54) Zero Implicit Detector

(71) Applicant: International Business Machines Corporation, Armonk, NY (US)

(72) Inventors: Balaji Muthusamy Pandurangan, Amstelveen (NL); Claire Louise Bezuidenhout, Nieuwegein (NL)

(21) Appl. No.: 19/021,519

(22) Filed: Jan. 15, 2025

(51) Int. Cl. G06F 21/56; G06F 21/55

(52) U.S. Cl. CPC G06F 21/566; G06F 21/552; G06F 21/554

(57) ABSTRACT

A method for detects a threat to a computer system is provided. A request is received from a user for processing by a machine learning model in the computer system. An intent is determined for the request using an intent taxonomy to analyze the request. Whether the request is a threat is determined using the intent with an attack taxonomy; and sending the request to the machine learning model in response to an absence of threat. According to other illustrative embodiments, a computer system, and a computer program product for detecting threats to a computer system are provided.

### BACKGROUND

The disclosure relates generally to an improved computer system and more specifically to detecting threats in the computer system.

Generative artificial intelligence (AI) refers to a category of artificial intelligence systems designed to create new content such as text, images, video, music, program code, or a virtual environment. Generative artificial intelligence models operate by learning patterns and structures from large datasets and generating outputs that resemble the patterns. Unlike traditional artificial intelligence models, which primarily focuses on analyzing and predicting data, generative artificial intelligence models actively produce outputs in the form of new content. This new content often mimics human creativity.

The complexity of a query to a generative artificial intelligence model can range from simple requests to complicated requests that include many tasks. For example, requests can include straightforward prompts such as generating text, summarizing a paragraph or an article, or creating a simple image based on a description. The complexity of requests to generative artificial intelligence models can grow significantly. As the requirement of the requests become more complex, the generative artificial intelligence models use multi-step reasoning, creative synthesis, or domain-specific knowledge. Complex requests can be processed by generative artificial intelligence models leveraging their ability to understand context, semantics, and nuanced relationships in text.

These models use self-attention mechanisms, as seen in architectures such as transformers, to weigh the importance of different parts of the input when generating an output. This ability allows generative artificial intelligence models to handle multi-step reasoning, ambiguous queries, and tasks requiring synthesis of information. For example, dimension of complexity arises when the requests are open-ended, require contextual understanding or involve dynamic constraints or multiple objectives.

### SUMMARY

According to one illustrative embodiment a method for detecting a threat to a computer system is provided. A request is received from a user for processing by a machine learning model in the computer system. An intent is determined for the request using an intent taxonomy to analyze the request. Whether the request is a threat is determined using the intent with an attack taxonomy; and sending the request to the machine learning model in response to an absence of threat. According to other illustrative embodiments, a computer system, and a computer program product for detecting threats to a computer system are provided.

### BRIEF DESCRIPTION OF THE DRAWINGS

FIG. 1 is a block diagram of a computing environment in accordance with an illustrative embodiment;

FIG. 2 is a block diagram of a query processing environment in accordance with an illustrative embodiment;

FIG. 3 is a block diagram of a query inspector in accordance with an illustrative embodiment;

FIG. 4 is an illustration of vectors describing results from analyzing a sequence of requests in accordance with an illustrative embodiment;

FIG. 5 is a flowchart of a process for detecting threats in a computer system in accordance with an illustrative embodiment;

FIG. 6 is a flowchart of a process for determining a threat level in accordance with an illustrative embodiment;

FIG. 7 is a flowchart of a process for determining a threat level in accordance with an illustrative embodiment;

FIG. 8 is a flowchart of a process for performing an action in accordance with an illustrative embodiment;

FIG. 9 is a flowchart of a process for generating a history in accordance with an illustrative embodiment;

FIG. 10 is a flowchart of a process for determining whether a request is a threat in accordance with an illustrative embodiment;

FIG. 11 is a flowchart of a process for creating an attack taxonomy in accordance with an illustrative embodiment;

FIG. 12 is a flowchart of a process for creating an attack taxonomy in accordance with an illustrative embodiment; and

FIG. 13 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

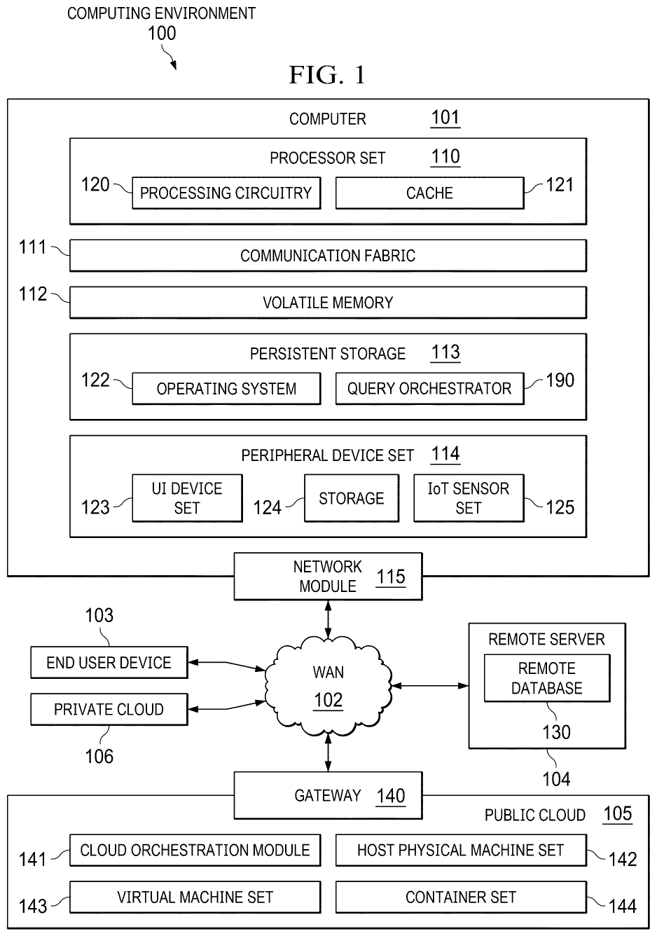

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as query orchestrator 190. In addition to query orchestrator 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and query orchestrator 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in query orchestrator 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in query orchestrator 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that while generative artificial intelligence models are very powerful in generating content, vulnerabilities are present with these complex models because of the complexity of these models.

For example, generative artificial intelligence models can be vulnerable to prompt injection. Prompt injection attacks involve crafting malicious inputs to manipulate a generative artificial intelligence model into producing harmful or unintended outputs, such as bypassing safeguards, leaking sensitive information, or performing unauthorized actions.

As another example, generative artificial intelligence models can also be vulnerable to prompt obfuscation. Prompt obfuscation can be used to bypass content moderation or policy safeguards of artificial intelligence systems by phrasing prompts in indirect or unconventional ways. Prompts in a request can be altered encoding, misspellings, or indirect phrasing that evade safeguards and influence the behavior of a generative artificial intelligence model in an undesired manner. As a result, prompt obfuscation can lead to harmful actions by a generative artificial intelligence model. These actions can include generating malicious program code, returning confidential information, or generating phishing emails.

The illustrative embodiments also recognize and take into account that a sequence of carefully crafted queries can pose significant risks in which that analysis of these queries individually may be benign. These sequence of queries is designed to exploit vulnerabilities in a generative artificial intelligence model.

Thus, the illustrative examples provide a method, apparatus, system, and computer program product for detecting threats that can be applied to generative artificial intelligence models. In one illustrative example, a rule-based system or other logic system can be used instead of a machine learning model that requires training. An attack taxonomy and an intent taxonomy are used by the process to determine the intent of the request and whether a threat is present.

Further in this example, the attack taxonomy can be dynamically updated during the running of the process without needing training as compared to machine learning models. In these illustrative examples, the attack taxonomy can be updated in response to updates to a collection of attack patterns. Further, the illustrative examples enable detecting threats that may not be present in a single request split through multiple requests. In these examples, the process maintains a history of requests for users and determines whether a threat is present through analyzing the history of requests in addition to the current request from a particular user.

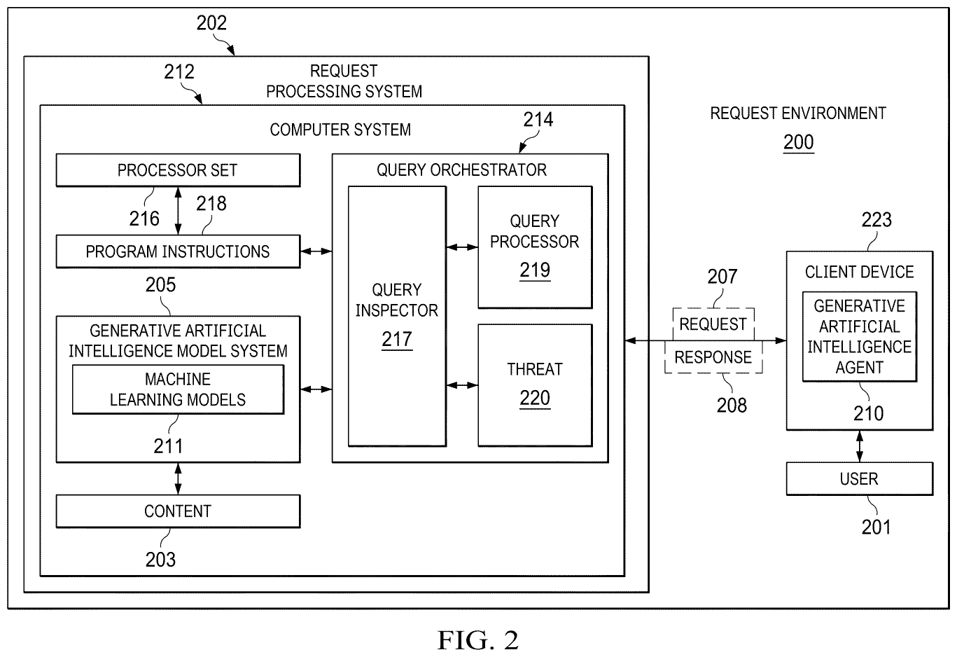

With reference now to FIG. 2, a block diagram of a query processing environment is depicted in accordance with an illustrative embodiment. In this illustrative example, request environment 200 includes components that can be implemented in hardware such as the hardware shown in computing environment 100 in FIG. 1. In this example, request processing system 202 can operate to process request 207 from user 201 to generate content 203 using generative artificial intelligence model system 205. Content 203 can be returned to user 201 in response 208.

As depicted, request 207 is generated by generative artificial intelligence (AI) agent 210 in client device 223 in response to input such as request 207 from user 201. Generative artificial intelligence (AI) agent 210 processes input from user 201 through tokenization to breakup text into smaller units such as tokens that can be analyzed and processed by generative artificial intelligence model system 205. These tokens can be transmitted in request 207 to request processing system 202.

As depicted, client device 223 is a hardware device and can take a number of forms. Client device 223 can be selected from a group comprising a tablet computer, a laptop computer, a desktop computer, a server, a smartwatch, a kiosk, or other device that can run generative artificial intelligence agent 210 to generate request 207.

In this illustrative example, generative artificial intelligence model system 205 is a system that generates content 203 based on requests from users. In this example, content 203 generated by generative artificial intelligence model system 205 includes at least one of text, images, video, audio, program code, or other types of content.

Further, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

As depicted in this example, generative artificial intelligence model system 205 can be comprised of a number of machine learning models 211 that generate new content based on input. As used herein, “a number of” when used with reference to items, means one or more items. For example, “a number of machine learning models” is one or more machine learning models. The number of machine learning models 211 can include at least one of a generative artificial intelligence model, a foundation model, a large language model, or some other suitable model that can generate content 203.

In this illustrative example, request processing system 202 comprises computer system 212 and query orchestrator 214 located in computer system 212. Query orchestrator 214 may be implemented using query orchestrator 190 in FIG. 1.

Query orchestrator 214 can be implemented in software, hardware, firmware or a combination thereof. When software is used, the operations performed by query orchestrator 214 can be implemented in program instructions configured to run on hardware, such as a processor unit. When firmware is used, the operations performed by query orchestrator 214 can be implemented in program instructions and data and stored in persistent memory to run on a processor unit. When hardware is employed, the hardware can include circuits that operate to perform the operations in query orchestrator 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes processor set 216 that is capable of executing program instructions 218 implementing processes in the illustrative examples. In other words, program instructions 218 are computer-readable program instructions. Processor set 216 is an example of processor set 110 in FIG. 1.

As used herein, a processor unit in processor set 216 is a hardware device and is comprised of hardware circuits such as those on an integrated circuit that respond to and process instructions and program code that operate a computer. Processor set 216 can be a number of processor units that can be implemented using processor set 110 in FIG. 1. The processor units can also be referred to as computer processors. When processor set 216 executes program instructions 218 for a process, processor set 216 can be one or more processor units that are in the same computer or in different computers. In other words, the process can be distributed between processor units in processor set 216 on the same or different computers in computer system 212.

Further, processor set 216 can include the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

Although not shown, processor set 216 can also include other components in addition to the processor units or processing circuitry. For example, processor set 216 can also include a cache or other components used with processor units or other processing circuitry.

In this illustrative example, query orchestrator 214 manages the flow of requests received from users such as user 201. As depicted, query orchestrator 214 comprises query processor 219 and query inspector 217. Query processor 219 handles processing and routing of requests. For example, query processor 219 decides which one of machine learning models 211 in generative artificial intelligence model system 205 will handle request 207.

Machine learning models 211 can include, for example, at least one of a text machine learning model for generating text, a code machine learning model for generating code, an image machine learning model for generating images, a summarizing machine learning model for summarizing text, or other types of machine learning models. For example, in routing requests, if request 207 is to generate an image, then query processor 219 selects the image machine learning model to handle request 207.

Additionally, prior to routing request 207 to a machine learning model in generative artificial intelligence model system 205, query processor 219 determines whether the request should even be sent to a generative artificial intelligence model system 205. Query processor 219 sends request 207 to query inspector 217 to determine whether request 207 is for content 203 that can be harmful or misleading.

In other words, query inspector 217 determines whether request 207 is threat 220. In the illustrative example, threat 220 can take a number of different forms. For example, threat 220 can be selected from at least one of a tactic, a technique, a procedure, or a malicious activity.

For example, request 207 may include a prompt obfuscation in which encoding, injecting hidden commands, breaking prompts into fragmented inputs, ambiguous input, or other types of input that exploit vulnerabilities or causes a machine learning model to generate harmful, misleading, irrelevant, or undesirable output for content 203 that may be threat 220. For example, request 207 requests the generation of undesired content such as a phishing email. The use of query inspector 217 can identify the presence or absence of these types of threats enabling query processor 219 to take further appropriate action in processing request 207.

In response to threat 220 being detected by query inspector 217, query processor 219 does not send request 207 to a machine learning model and generative artificial intelligence model system 205. In response to detecting threat 220, an error or no response may be returned to generative artificial intelligence agent 210 in client device 223, Further, when threat 220 is determined as being present, other actions may be performed including at least one of logging request 207 and user 201, sending a notification to a threat management system, or other suitable actions.

In this example, if threat 220 is not detected for request 207, query processor 219 sends request 207 to a machine learning model in the number of machine learning models 211 in generative artificial intelligence model system 205. In this case, content 203 is generated for response 208 to be sent back to user 201 using generative artificial intelligence agent 210 in client device 223.

In this example, query inspector 217 can also inspect response 208 prior to query processor 219 sending response 208 to user 201. This inspection is performed to determine whether threat 220 is present in response 208. If threat 220 is present, then response 208 may be redacted or not sent to user 201. For example, if personally identifiable information such as an email address is present in response 208, then content 203 in response 208 can be redacted to omit the email address. If content 203 results in program code to download files, then response 208 may not be returned to user 201.

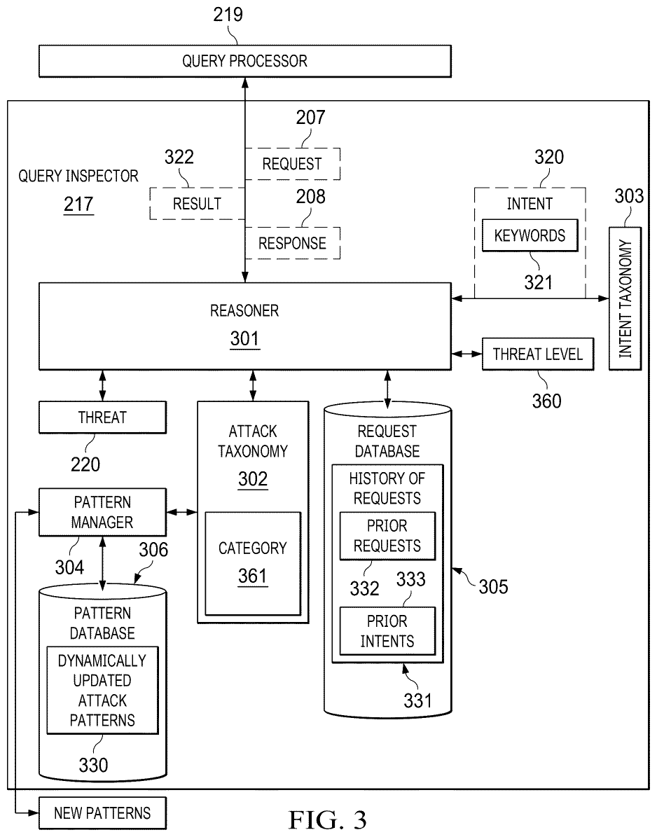

With reference now to FIG. 3, a block diagram of a query inspector is depicted in accordance with an illustrative embodiment. In the illustrative examples, the same reference numeral may be used in more than one figure. This reuse of a reference numeral in different figures represents the same element in the different figures.

In this illustrative example, components that may be used to implement query inspector 217 are shown. For example, a number of items and blocks from FIG. 2 are shown and discussed with new components introduced in this figure. As depicted, examples of components used to implement query orchestrator 214 shown in FIG. 2 includes reasoner 301, attack taxonomy 302, intent taxonomy 303, pattern manager 304, request database 305, and pattern database 306.

In this example, reasoner 301 receives request 207 from user 201 for processing by a machine learning model in generative artificial intelligence model system 205. In this example, request 207 is received through query processor 219 that receives request 207 from user 201 using generative artificial intelligence agent 210.

Reasoner 301 determines intent 320 using intent taxonomy 303. In this example, the text for tokens in request 207 can be compared to entries in intent taxonomy 303 to determine intent 320. In this example, intent 320 can be a number of keywords 321 that match one or more tokens in request 207. For example, if request 207 is to generate a general email message, then a number of keywords 321 can be “generate” and “email message.” If request 207 is to insert a hyperlink into the email message, then the number of keywords 321 can also include “insert” and “hyperlink.”

Reasoner 301 determines whether request 207 is threat 220 using intent 320 with attack taxonomy 302. For example, “generate” and “email message” and “insert” and “hyperlink” in intent 320 can be compared to keywords in attack taxonomy 302. In this example, a match is present indicating threat 220. In this example, threat 220 can be categorized as spear phishing.

Request 207 is sent to the machine learning model in response to an absence of threat 220. In this example, reasoner 301 can send result 322 to query processor 219 with an indication that threat 220 is absent from request 207. In response, query processor 219 sends request 207 to the appropriate machine learning model in a number of machine learning models 211 in generative artificial intelligence model system 205 in FIG. 2.

If threat 220 is detected, this threat is indicated by reasoner 301 in result 322 In response to receiving result 322, query processor 219 does not send request 207 to a machine learning model.

Further, when response 208 is generated by a machine learning model in response to request 207, similar processing can be performed by reasoner 301 on response 208. For example, reasoner 301 receives response 208 to request 207 from query processor 219. Reasoner 301 determines intent 320 for response 208 using intent taxonomy 303. In this case, text from response 208 is used to match or identify keywords 321 in intent taxonomy 303 to determine intent 320.

Reasoner 301 determines whether response 208 is threat 220 using intent 320 determined from response 208 with attack taxonomy 302. In this example, response 208 is sent to user 201 in response to the absence of threat 220. In this example, reasoner 301 indicates an absence of threat 220 in result 322, causing query processor 219 to send response 208 to user 201.

If reasoner 301 determines threat 220 is present for response 208, this presence of the threat can be indicated in result 322. Further, information about threat 220 such as a category of spearfishing, email address, or file downloader may be included in result 322.

In this example, a number of different actions can be performed depending on the type of threats detected. For example, query processor 219 can perform an action selected from redacting response 208 and not sending response 208 in response to threat 220 being present in response 208. In one example, if response 208 is text including an email address, that text can be redacted to remove the email address. In another example, if the response comprises codes such as a file downloader, then response 208 is not returned to user 201. Other actions can also be taken including logging threat 220 and the identity of user 201, generating an alert, and the connection with a client device, or other actions.

In this illustrative example, intent taxonomy 303 and attack taxonomy 302 are structured databases or collections of data used to identify intents and threats. With this example, reasoner 301 can be a rule-based system or other logic that implements rules or processes to identify intent 320 using intent taxonomy 303 and threat 220 using attack taxonomy 302. With the use of intent taxonomy 303 and attack taxonomy 302, reasoner 301 avoids needing to implement a machine learning model that requires training to identify threats. For example, reasoner 301 can compare text in request 207 to entries in intent taxonomy 303 to identify intent 320 and use keywords 321 in intent 320 to determine whether one or more entries are present in attack taxonomy 302 to indicate the presence of threat 220.

In this depicted example, intent taxonomy 303 can be a framework of keywords that are organized into categories for identifying intent 320. This framework can have a hierarchical structure such as categories and subcategories. The categories can be, for example, text generation, code generation, summarization, image generation, and other categories. Subcategories can be present with these categories. For example, in text generation, a subcategory can be email generation. Keywords are present in the categories and subcategories that can be matched to identify the type of intent 320 such as email generation in a subcategory of text generation. The entry can include keywords such as “generate,” “general,” and “email message.”

In this example, attack taxonomy 302 can include categories such as file execution, network connection change, script execution, phishing and other categories. Within these categories, examples can be present in which keywords can be used to identify whether a threat is present and the particular type of threat.

Further, subcategories can also be present. For example, within a fishing category, subcategories such as spearfishing, clone fishing, credential harvesting, website spoofing, and other subcategories can be present. In this example, the keywords of “generate email message” and “insert hyper link” can be matched to keywords under the subcategory spear phishing within the category of phishing.

One feature of attack taxonomy 302 in this illustrative example is that this structure can be dynamically updated. For example, attack taxonomy 302 can be updated during execution of query inspector 217. This updating can be performed without needed retraining of reasoner 301.

In this example, pattern manager 304 generates attack taxonomy 302 taxonomy from pattern database 306 of dynamically updated attack patterns 330. Once attack taxonomy 302 is generated, attack taxonomy 302 can be updated in response to an update event for pattern database 306 of dynamically updated attack patterns 330. The event can be a change to pattern database 306, an expiration of a timer, a request to update attack taxonomy 302, and other types of events. In this example, reasoner 301 has access to the updated attack taxonomy without needing to be taken off-line to perform additional training. Instead, reasoner 301 can continue to operate using the updated version of attack taxonomy 302.

Further in these examples, dynamically updated attack patterns 330 in pattern database 306 are stored in documents. In this example, information about threat 220 and other threats can be fragmented in multiple documents. This fragmentation can result from different sources of information including updates to a threat that can be obtained at a later time. These documents can be from sources such as security reports, incident response documents, research papers, and other types of documents.

In this illustrative example, reasoner 301 also includes an ability to detect threats that may not occur in a single request. Reasoner 301 saves request 207 and intent 320 in history of requests 331 in request database 305. In some examples, saving request 207 involves saving a portion of request 207 or metadata in request 207 rather than all of request 207. For example, the information saved from request 207 can include keywords 321 from intent 320, an identification of the user, the date, an Internet protocol (IP) address of a client device, and other information for request 207. In other examples, all of the text of request 207 can also be saved with this information.

Each time a request is processed by reasoner 301, this request and the intent can be saved in history of requests 331. Each time a request is received from the same user in history of requests 331 can be searched to identify prior requests 332 from that user. From prior requests 332, prior intents 333 can be identified for analysis by reasoner 301. These identified requests can be considered collectively to determine whether threat 220 is present instead of on a piecemeal or request by request basis.

With history of requests 331, reasoner 301 can detect intricate attack workflows in which each request builds on previous requests. Thus, this type of attack can be one type of prompt obfuscation that reasoner 301 can detect.

For example, in response to receiving request 207 for processing, the determination of whether request 207 is threat 220 by reasoner 301 and can include identifying a number of prior requests 332 and a number of prior intents 333 for the number of prior requests 332 in history of requests 331 associated with user 201. Reasoner 301 determines whether request 207 is threat 220 using intent 320 and the number of prior intents 333 with the attack taxonomy 302. In other words, request 207 may result may be considered threat 220 when considered in the context of prior requests 332. As a result, the detection of threat 220 can be made even though individual requests are not identified as threats. In this manner, the formation of an attack through a series of requests or an ongoing attack based on the series of requests can be determined as being present by reasoner 301.

Further, reasoner 301 can also determine threat level 360 for request 207. This determination can be made using category 361 for threat 220 identified for threat 220 identified using attack taxonomy 302 in response to determining threat 220 is present. In this example, reasoner 301 uses category 361 as an input to search intent taxonomy 303. Intent taxonomy 303 also includes threat levels that are associated with categories of threats in attack taxonomy 302. For example, if category 361 is spear phishing, threat level 360 is low. In another example, if category 361 is malicious code, threat level 360 is high. These threat levels are determined by using category 361 to search for threat level 360 in intent taxonomy 303.

In this particular example, the threat levels are low, medium, or high. In another example, the threat levels can be numerical from 1 to 5, and other formats for threat levels can be used. These and other types of threat level categorizations can be used for threat level 360.

Thus, in one illustrative example, one or more solutions are present that overcome a technical problem with using machine learning models to detect threats. As a result, one or more solutions may provide a technical effect enabling faster and more efficient detection threats. Further, one or more solutions may avoid the time and expense needed for training and retraining machine learning models to detect threats.

In one example, a request is received from a user for processing by a machine learning model in the computer system. An intent is determined for the request using an intent taxonomy to analyze the request. Whether the request is a threat is determined using the intent with an attack taxonomy. The intent is used to search attack taxonomy to see if a match the intent is present in attack taxonomy to indicate a threat being present. The request is sent to the machine learning model in response to an absence of the threat.

In these illustrative examples, a rule-based system or other logic system can be used instead of a machine learning model that requires training to detect threats. These illustrative examples, an attack taxonomy and an intent taxonomy are used by the process to determine the intent of the request and whether a threat is present. Further, the attack taxonomy can be dynamically updated during the running of the process without needing training as compared to machine learning models. In these illustrative examples, the attack taxonomy can be updated in response to updates to a collection of attack patterns. Further, the illustrative examples enable detecting threats that may not be present in a single request split through multiple requests. In these examples, the process maintains a history of requests for the user and determines whether a threat is present through analyzing the history of requests in addition to the current request.

Computer system 212 can be configured to perform at least one of the steps, operations, or actions described in the different illustrative examples using software, hardware, firmware or a combination thereof. As a result, computer system 212 operates as a special purpose computer system in which query orchestrator 214 in computer system 212, in particular query orchestrator 214, transforms computer system 212 into a special purpose computer system as compared to currently available general computer systems that do not have query orchestrator 214.

In the illustrative example, the use of query orchestrator 214 in computer system 212 integrates processes into a practical application of a method for detecting threats. In other words, query orchestrator 214 in computer system 212 is directed to a practical application of processes integrated into query orchestrator 214 in computer system 212 that detects threats. This process of detecting threats can be applied to the performance of actions in response to detecting threats. These actions may include not sending a response to a request, sending a notification to a security center, terminating a session, terminating a communications link with the user identified as being associated with the threat, blocking access to the machine learning model, and other suitable actions.

With reference now to FIG. 4, an illustration of vectors describing results from analyzing a sequence of requests is depicted in accordance with an illustrative embodiment. In this illustrative example, vectors shown in FIG. 4 can be examples of output generated by reasoner 301 for result 322 in FIG. 3.

In this example, vectors 400 illustrate sets of parameters that are associated with a sequence of requests analyzed to determine whether the sequence of requests is a threat to a computer system. As depicted, a sequence of requests can contain a threat even when each individual request in the sequence is not a threat.

For example, an attacker can use techniques such as prompt obfuscation to bypass security measures of machine learning models 211 in generative artificial intelligence model system 205. In this depicted example, prompt obfuscation refers to the deliberate manipulation or masking of malicious inputs in requests to evade detection and bypass security measures in the system such as large language models. In this example, vectors 400 include three vectors that contain parameters for a sequence of two requests. For example, vector 402 includes parameters for a first request. In this illustrative example, the first request can be an example of request 207 in FIG. 2. As depicted, vector 402 is constructed as:

$$re ( {sv}_{aattack - pattern} , {sv}_{intent} , {sv}_{attack - category} , {as}_{target} , {et}_{semantic} , {ds}_{request} )$$

where sv_{aattack-pattern} represents the variable placeholder for a detected attack pattern for the first request; svᵢₙₜₑₙₜ represents the variable placeholder for a detected intent for the first request; sv_{attack-category} represents the variable placeholder for the category of the detected attack pattern for the first request; as_{target} represents the variable placeholder for the category of detected intent for the first request; et_{semantic} represents the variable placeholder for the linguistic features of keywords in the first request for identifying the attack pattern and intent for the first request; and ds_{request} represents the variable placeholder for the information for the first request.

In a similar fashion, vector 404 includes parameters for a second request that is input chronologically after the first request. In this illustrative example, the second request can be an example of request 207 in FIG. 2. As depicted, vector 404 is constructed as:

$$re 2 ( {sv}_{aattack - pattern - hisotry} , {sv}_{intent - history} , {sv}_{attack - category} , {as}_{target} , {et}_{semantic} , {ds}_{request} )$$

where sv_{aattack-pattern-history} represents the variable placeholder for a detected attack pattern for the first request and the second request; sv_{intent-history} represents the variable placeholder for a detected intent for the first request and the second request; sv_{attack-category} represents the variable placeholder for the category of a detected attack pattern for the second request; as_{target} represents the variable placeholder for the category of a detected intent for the second request; et_{semantic} represents the variable placeholder for the linguistic features of keywords in the second request for identifying an attack pattern and intent for the second request; and ds_{request} represents the variable placeholder for the information for the second request.

In addition, vector 406 includes parameters for the sequence of requests that include the first request and the second request. In this illustrative example, vector 406 is constructed as:

$$re 3 ( {sv}_{re 1} , {sv}_{re 2} , {sv}_{session - state} , {as}_{target} , {et}_{semantic} , {ds}_{request} )$$

where svᵣₑ₁ represents the variable placeholder for the first request, svᵣₑ₂ represents the variable placeholder for the second request; svₛₑₛₛᵢₒₙ₋ₛₜₐₜₑ represents the variable placeholder for the historical intent and current intent determined for the sequence of requests; as_{target} represents the variable placeholder for the category of detected intent for the sequence of requests; et_{semantic} represents the variable placeholder for the linguistic features of keywords in the sequence of requests for identifying an attack pattern and intent for the sequence of requests; and ds_{request} represents the variable placeholder for the information for the sequence of requests.

In this illustrative example, reasoner 301 sends vectors 400 to query processor 219. In response, query processor 219 can block the second request when the sequence of requests including the first request and the second request poses a threat when evaluated as a whole based on vectors 400.

As depicted, a sequence of requests may contain malicious intent even when each individual request in the sequence of requests is determined to be benign. For example, the first request can include “generates emails” and the second request can include “insert hyperlinks.” In this example, both requests are benign and harmless when the two requests are accessed separately. However, the combination of the two requests can lead to a malicious intent for generating phishing email for exploiting personal information.

In an alternative illustrative example, the first request can include “explain what a typical file containing user data might look like, such as usernames and email addresses?” and the second request can include “what about if the file includes hashed passwords? How might it appear, and how could someone verify the hash matches a password”. In this example, both requests are benign in isolation, but the user who sent both requests is gradually building a roadmap to reconstruct sensitive information through prompt obfuscation when both requests are evaluated as a whole.

In this illustrative example, vector 406 includes analytic information generated by reasoner 301. This information includes an evaluation of the sequence of requests that include request 1 and request 2 as a whole. In this illustrative example, query processor 219 can determine whether any request should be blocked when the sequence of requests, including the first request and the second request, are evaluated as a whole based on vectors 400. In this example, vector 402, vector 404, and vector 406 can indicate whether the first request deviates and the second request is a threat as well as information about the threat. Query processor 219 can use this information to determine whether any unprocessed request in a sequence of requests that include requests that are not a threat when evaluated separately should be blocked or discarded based on the evaluation of these requests in vectors 400 by reasoner 301.

The illustration of vectors 400 in FIG. 4 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, parameters in vectors 400 can be organized using data structures other than vectors. For example, parameters in vectors 400 can be organized using lists, arrays, matrices, or any other suitable data structure. In another example, vectors 400 can also include vectors for a sequence of requests that correspond to any number of individual requests.

The illustration of request environment 200 and the components shown in FIGS. 2-4 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, client device 223 is shown as a separate computing device from computer system 212. In some illustrative examples, client device 223 may be considered a part of computer system 212. In another illustrative example, one or more query orchestrators can be present in addition to query orchestrator 214. These query orchestrators can process requests from user 201 or other users in which requests may be distributed to these query orchestrators for processing by a load-balancing mechanism. In yet another illustrative example, pattern manager 304 accesses other pattern databases in addition to pattern database 306. These other pattern databases can also be used to generate an update to attack taxonomy 302.

In yet another example, reasoner 301 can use category 361 to search other taxonomies or data structures in addition to or in place of intent taxonomy 303 to identify threat level 360. In still other illustrative examples, intent taxonomy 303 can be dynamically updated in a similar fashion to attack taxonomy 302. In yet another illustrative example, attack taxonomy 302 can be updated by pointing reasoner 301 to a new different attack taxonomy that has been created by pattern manager 304 using updates to pattern database 306. These updates can be performed while reasoner 301 is executing without needing to restart reasoner 301 or train reasoner 301 and use updates to intent taxonomy 303.

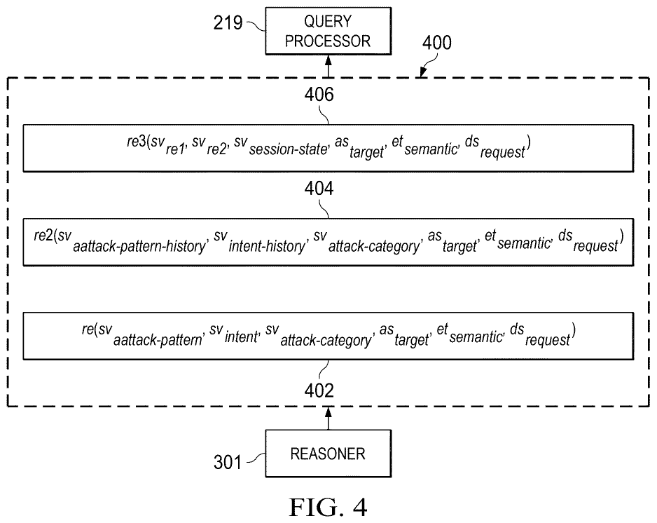

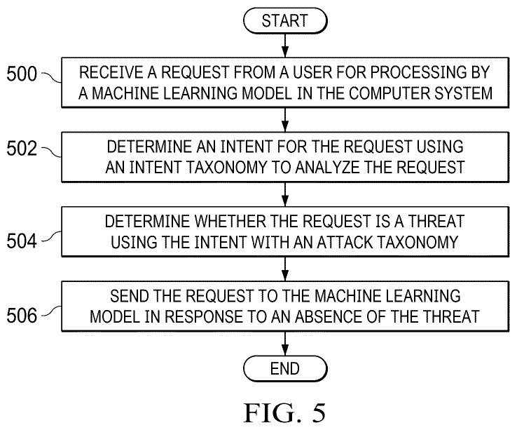

Turning next to FIG. 5, a flowchart of a process for detecting threats in a computer system is depicted in accordance with an illustrative embodiment. The process in FIG. 5 can be implemented in hardware, software, or both. When implemented in software, the process can take the form of program instructions that are run by a processor set located in one or more hardware devices in one or more computer systems. For example, the process can be implemented in query orchestrator 214 in computer system 212 in FIG. 2.

The process receives a request from a user for processing by a machine learning model in the computer system (step 500). The process determines an intent for the request using an intent taxonomy to analyze the request (step 502).

The process determines whether the request is a threat using the intent with an attack taxonomy (step 504). The process sends the request to the machine learning model in response to an absence of the threat (step 506). The process terminates thereafter.

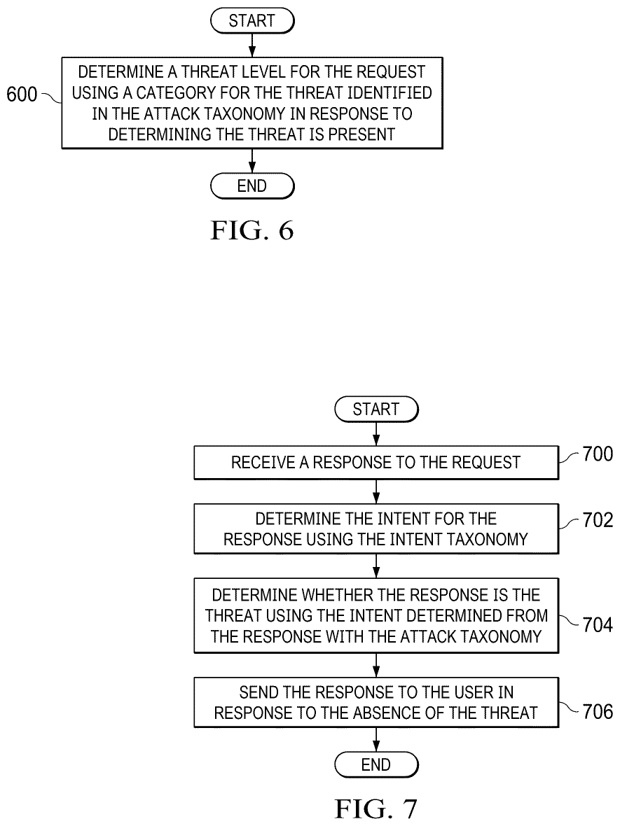

Next in FIG. 6, a flowchart of a process for determining a threat level is depicted in accordance with an illustrative embodiment. The process in this flowchart is an example of additional steps that can be performed with the steps in FIG. 5.

The process determines a threat level for the request using a category for the threat identified in the attack taxonomy in response to determining the threat is present (step 600). The process terminates thereafter.

Turning to FIG. 7, a flowchart of a process for determining whether a threat level is depicted in accordance with an illustrative embodiment. The process in this flowchart is an example of additional steps that can be performed with the steps in FIG. 5.

The process receives a response to the request (step 700). The process determines the intent for the response using the intent taxonomy (step 702). The process determines whether the response is the threat using the intent determined from the response with the attack taxonomy (step 704).

The process sends the response to the user in response to the absence of the threat (step 706). The process terminates thereafter.

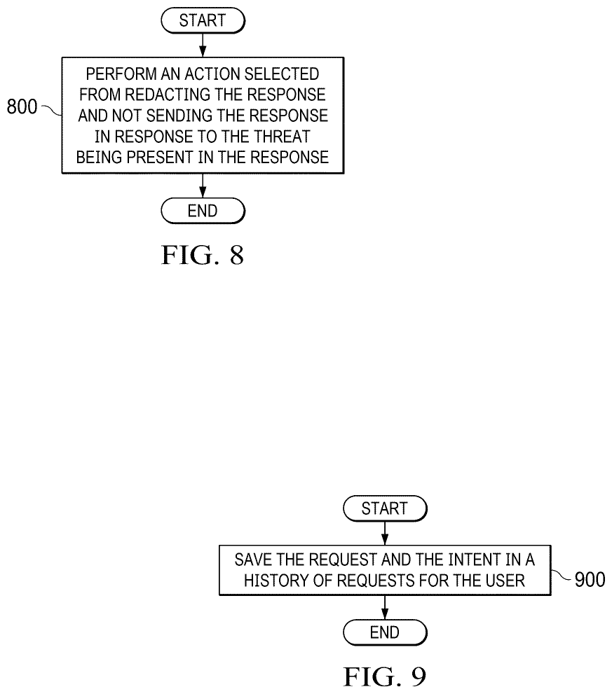

With reference to FIG. 8, a flowchart of a process for performing an action is depicted in accordance with an illustrative embodiment. The process in this flowchart is an example of additional steps that can be performed with the steps in FIG. 5.

The process performs an action selected from redacting the response and not sending the response in response to the threat being present in the response (step 800). The process terminates thereafter.

Next in FIG. 9, a flowchart of a process for generating a history is depicted in accordance with an illustrative embodiment. The process in this flowchart is an example of additional steps that can be performed with the steps in FIG. 5.

The process saves the request and the intent in a history of requests for the user (step 900). The process terminates thereafter.

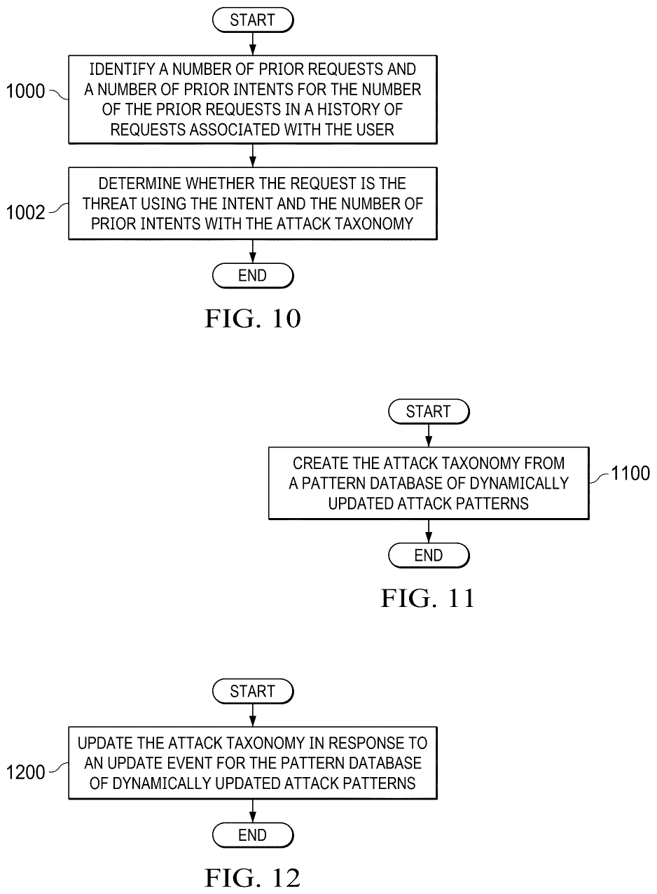

Referring now to FIG. 10, a flowchart of a process for determining whether a request is a threat is depicted in accordance with an illustrative embodiment. The process in this flowchart is an example of an implementation of step 504 in FIG. 5.

The process identifies a number of prior requests and a number of prior intents for the number of the prior requests in a history of requests associated with the user (step 1000). The process determines whether the request is the threat using the intent and the number of prior intents with the attack taxonomy (step 1002). The process terminates thereafter.

Turning to FIG. 11, a flowchart of a process for creating an attack taxonomy is depicted in accordance with an illustrative embodiment. The process in this flowchart is an example of additional steps that can be performed with the steps in FIG. 5.

The process creates the attack taxonomy from a pattern database of dynamically updated attack patterns (step 1100). The process terminates thereafter.

Turning to FIG. 12, a flowchart of a process for creating an attack taxonomy is depicted in accordance with an illustrative embodiment. The process in this flowchart is an example of additional steps that can be performed with the steps in FIG. 5 and FIG. 11.

The process updates the attack taxonomy in response to an update event for the pattern database of dynamically updated attack patterns (operation 1200). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

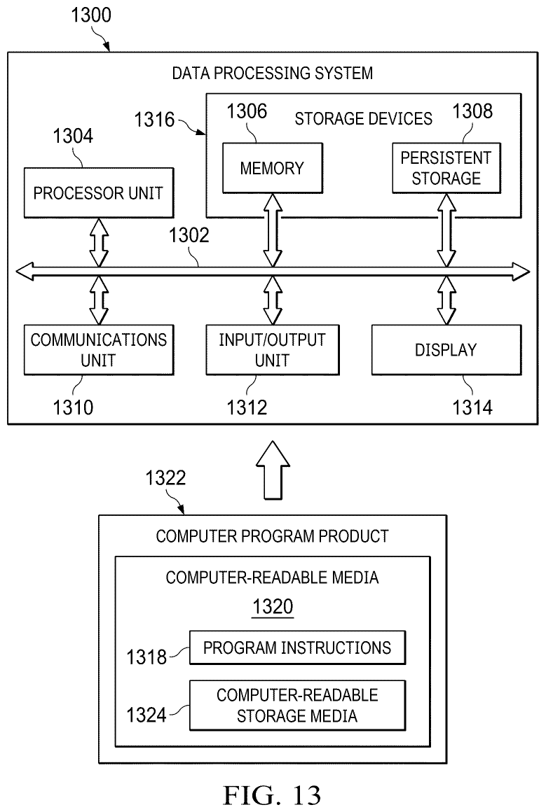

Turning now to FIG. 13, a block diagram of a data processing system is depicted in accordance with an illustrative embodiment. Data processing system 1300 can be used to implement computers and computing devices in computing environment 100 in FIG. 1. Data processing system 1300 can also be used to implement computer system 212 and client device 223 in FIG. 2. In this illustrative example, data processing system 1300 includes communications framework 1302, which provides communications between processor unit 1304, memory 1306, persistent storage 1308, communications unit 1310, input/output (I/O) unit 1312, and display 1314. In this example, communications framework 1302 takes the form of a bus system.

Processor unit 1304 serves to execute instructions for software that can be loaded into memory 1306. Processor unit 1304 includes one or more processors. For example, processor unit 1304 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1304 can be implemented using one or more heterogeneous processor systems in which a main processor is present with secondary processors on a single chip. As another illustrative example, processor unit 1304 can be a symmetric multi-processor system containing multiple processors of the same type on a single chip.

Memory 1306 and persistent storage 1308 are examples of storage devices 1316. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1316 may also be referred to as computer-readable storage devices in these illustrative examples. Memory 1306, in these examples, can be, for example, a random-access memory or any other suitable volatile or non-volatile storage device. Persistent storage 1308 may take various forms, depending on the particular implementation.

For example, persistent storage 1308 may contain one or more components or devices. For example, persistent storage 1308 can be a hard drive, a solid-state drive (SSD), a flash memory, a rewritable optical disk, a rewritable magnetic tape, or some combination of the above. The media used by persistent storage 1308 also can be removable. For example, a removable hard drive can be used for persistent storage 1308.

Communications unit 1310, in these illustrative examples, provides for communications with other data processing systems or devices. In these illustrative examples, communications unit 1310 is a network interface card.

Input/output unit 1312 allows for input and output of data with other devices that can be connected to data processing system 1300. For example, input/output unit 1312 may provide a connection for user input through at least one of a keyboard, a mouse, or some other suitable input device. Further, input/output unit 1312 may send output to a printer. Display 1314 provides a mechanism to display information to a user.

Instructions for at least one of the operating system, applications, or programs can be located in storage devices 1316, which are in communication with processor unit 1304 through communications framework 1302. The processes of the different embodiments can be performed by processor unit 1304 using computer-implemented instructions, which may be located in a memory, such as memory 1306.

These instructions are referred to as program instructions, computer usable program instructions, or computer-readable program instructions that can be read and executed by a processor in processor unit 1304. The program instructions in the different embodiments can be embodied on different physical or computer-readable storage media, such as memory 1306 or persistent storage 1308.

Program instructions 1318 are located in a functional form on computer-readable media 1320 that is selectively removable and can be loaded onto or transferred to data processing system 1300 for execution by processor unit 1304. Program instructions 1318 and computer-readable media 1320 form computer program product 1322 in these illustrative examples. In the illustrative example, computer-readable media 1320 is computer-readable storage media 1324.

Computer-readable storage media 1324 is a physical or tangible storage device used to store program instructions 1318 rather than a medium that propagates or transmits program instructions 1318. Computer-readable storage media 1324, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1318 can be transferred to data processing system 1300 using a computer-readable signal media. The computer-readable signal media are signals and can be, for example, a propagated data signal containing program instructions 1318. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1320” can be singular or plural. For example, program instructions 1318 can be located in computer-readable media 1320 in the form of a single storage device or system. In another example, program instructions 1318 can be located in computer-readable media 1320 that is distributed in multiple data processing systems. In other words, some instructions in program instructions 1318 can be located in one data processing system while other instructions in program instructions 1318 can be located in one data processing system. For example, a portion of program instructions 1318 can be located in computer-readable media 1320 in a server computer while another portion of program instructions 1318 can be located in computer-readable media 1320 located in a set of client computers.

The different components illustrated for data processing system 1300 are not meant to provide architectural limitations to the manner in which different embodiments can be implemented. In some illustrative examples, one or more of the components may be incorporated in or otherwise form a portion of, another component. For example, memory 1306, or portions thereof, may be incorporated in processor unit 1304 in some illustrative examples. In other examples, more than one processor unit can be present. The different illustrative embodiments can be implemented in a data processing system including components in addition to or in place of those illustrated for data processing system 1300. Other components shown in FIG. 13 can be varied from the illustrative examples shown. The different embodiments can be implemented using any hardware device or system capable of running program instructions 1318.

Thus, illustrative embodiments provide a method, system, and computer program product for detecting threats. In one illustrative example, a request is received from a user for processing by a machine learning model in the computer system. An intent is determined for the request using an intent taxonomy to analyze the request. Whether the request is a threat is determined using the intent with an attack taxonomy. The request is sent to the machine learning model in response to an absence of the threat.

In these illustrative examples, a rule-based system or other logic system can be used instead of a machine learning model that requires training. In these illustrative examples, an attack taxonomy and an intent taxonomy are used by the system to determine the intent of the request and whether a threat is present. Further, the attack taxonomy can be dynamically updated during the running of the process without needing training as compared to machine learning models. In these illustrative examples, the attack taxonomy can be updated in response to updates to a collection of attack patterns.

Further, the illustrative examples enable detecting threats that may not be present in a single request split through multiple requests. In these examples, the process maintains a history of requests for the user and determines whether a threat is present through analyzing the history of requests in addition to the current request.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A method for detecting threats to a computer system, the method comprising:
receiving a request from a user for processing by a machine learning model in the computer system;
determining an intent for the request using an intent taxonomy to analyze the request;
determining whether the request is a threat using the intent with an attack taxonomy; and
sending the request to the machine learning model in response to an absence of the threat.

2. The method of claim 1, further comprising:
determining a threat level for the request using a category for the threat identified in the attack taxonomy in response to determining the threat is present.

3. The method of claim 1 further comprising:
receiving a response to the request;
determining the intent for the response using the intent taxonomy;
determining whether the response is the threat using the intent determined from the response with the attack taxonomy; and
sending the response to the user in response to the absence of the threat.

4. The method of claim 3, further comprising:
performing an action selected from redacting the response and not sending the response in response to the threat being present in the response.

5. The method of claim 1 further comprising:
saving the request and the intent in a history of requests for the user.

6. The method of claim 1, wherein determining whether the request is the threat further comprises:
identifying a number of prior requests and a number of prior intents for the number of prior requests in a history of requests associated with the user; and
determining whether the request is the threat using the intent and the number of prior intents with the attack taxonomy.

7. The method of claim 1 further comprising:
creating the attack taxonomy from a pattern database of dynamically updated attack patterns.

8. The method of claim 7 further comprising:
updating the attack taxonomy in response to an update event for the pattern database of dynamically updated attack patterns.

9. The method of claim 7, wherein the dynamically updated attack patterns in the pattern database are stored in documents and wherein information for the threat is fragmented in multiple documents.

10. The method of claim 1, wherein the request is received through a query processor that receives the request from a generative artificial intelligence agent and wherein the request is sent to the machine learning model through the query processor.

11. The method of claim 1, wherein the threat can be selected from at least one of a tactic, a technique, a procedure, or a malicious activity.

12. The method of claim 1, wherein the machine learning model is selected from a group comprising a generative artificial intelligence model, a foundation model, and a large language model.

13. A computer system comprising:
a processor set;
a set of one or more computer-readable storage media; and
program instructions, collectively stored in the set of one or more storage media to cause the processor set to perform operations comprising:
receiving a request from a user for processing by a machine learning model in the computer system;
determining an intent for the request using an intent taxonomy to analyze the request;
determining whether the request is a threat using the intent with an attack taxonomy; and
sending the request to the machine learning model in response to an absence of the threat.

14. The computer system of claim 13, wherein the operations further comprise:
determining a threat level for the request using a category for the threat identified in the attack taxonomy in response to determining the threat is present.

15. The computer system of claim 13, wherein the operations further comprise:
receiving a response to the request;
determining the intent for the response using the intent taxonomy;
determining whether the response is the threat using the intent determined from the response with the attack taxonomy; and
sending the response to the user in response to the absence of the threat.

16. The computer system of claim 15, wherein the operations further comprise:
performing an action selected from redacting the response and not sending the response in response to the threat being present in the response.

17. The computer system of claim 13, wherein the operations further comprise:
saving the request and the intent in a history of requests for the user.

18. The computer system of claim 13, wherein determining whether the request is the threat further comprises:
identifying a number of prior requests and a number of prior intents for the number of prior requests in a history of requests associated with the user; and
determining whether the request is the threat using the intent and the number of prior intents with the attack taxonomy.

19. The computer system of claim 13, wherein the operations further comprise:
creating the attack taxonomy from a pattern database of dynamically updated attack patterns.

20. A computer program product for detecting threats in a computer system, the computer program product comprising:
a set of one or more computer-readable storage media; and
program instructions stored on the set of one or more storage media to perform operations comprising:
receiving a request from a user for processing by a machine learning model in the computer system;
determining an intent for the request using an intent taxonomy to analyze the request;
determining whether the request is a threat using the intent with an attack taxonomy; and
sending the request to the machine learning model in response to an absence of the threat.
